(19) United States
(12) Patent Application Publication
(10) Pub. No.: US 2026/0048988 A1
(43) Pub. Date: Feb. 19, 2026

(54) METHOD FOR PRODUCING GRAPHITE FROM PAPER

(71) Applicant: Nippon Kornmeyer Carbon Group GmbH, Windhagen (DE)

(72) Inventor: David KLEIN, Hennef (Sieg) (DE)

(73) Assignee: Nippon Kornmeyer Carbon Group GmbH, Windhagen (DE)

(21) Appl. No.: 19/103,775

(22) PCT Filed: Aug. 22, 2022
(86) PCT No.: PCT/EP2022/073326

§ 371 Date: Feb. 13, 2025

(51) Int. Cl. C01B 32/205

(52) U.S. Cl. CPC C01B 32/205

(57) ABSTRACT

A method for producing graphite from paper for use as a filter or construction material provides a cost-effective, simple and sustainable method for producing graphite. Paper/wastepaper, paper shreds or paper strips are soaked in water in a suitable container for several hours. The soaked paper is mixed and comminuted using a suitable device until a paste or a mixture having a paste-like consistency forms. Sugar or starch is added to the paste as a binder. The paste is inserted into a suitable mold, and the water is subsequently pressed out of the paste by pressing or the paste is isostatically pressed, so that a pressed product is formed. The dewatered pressed product is removed from the mold and carbonized in a furnace at >1000° C. and then graphitized at >2000° C. (at most up to 3000° C.).

### CROSS-REFERENCE TO RELATED APPLICATION

This application is a national stage application, filed under 35 U.S.C. § 371, of International Patent Application PCT/EP2022/073326, filed on Aug. 22, 2022.

### BACKGROUND

The disclosure relates to a process for producing graphite from paper for use as filter or building material

### SUMMARY

It is an object of the disclosure to provide an inexpensive, simple and sustainable process for producing graphite from paper, preferably used paper, which can be used as filter or building material.

The object is achieved by softening paper/used paper, paper scraps or paper strips in a suitable vessel over several hours in water, and subsequently comminuting the softened paper with a suitable apparatus until a paste or a mixture having paste-like consistency has formed, and in that a binder, such as sugar or starch, is mixed into the paste. This paste is introduced into a suitable mold and then the water is squeezed out of the paste by pressing, or the paste is subjected to isostatic pressing to obtain a briquet, which is subsequently dried.

Subsequently, the dried briquet can be removed from the mold as usual and carbonized in a furnace at >1000° C. and then graphitized at >2000° C. (up to a maximum of 3000° C.).

It will be apparent that both the carbonizing and the graphitizing have to be undertaken at least with exclusion of oxygen or under protective gas.

The softening of the paper should be undertaken over a period of about 24 hours.

In order that the dewatered briquet has better integrity and does not crumble after graphitization, a binder having good solubility in water, such as sugar or syrup, can be added to the softened paper, which can be well distributed in a uniform manner in the paste.

Alternatively, it is also possible to mix starch, such as potato starch, corn starch, rice starch or the like, as binder into the paste or mixture having paste-like consistency.

It is particularly advantageous when the briquet is dried prior to further processing, in order to reduce or to avoid later outgassing of volatile constituents, by means of which it is simultaneously possible to avoid the formation of cracks in the subsequent high-temperature treatment.

The drying can be effected in a drying cabinet or in a demoisturizing system, in order to accelerate the drying process.

### BRIEF DESCRIPTION OF THE DRAWINGS

The invention is explained hereinafter with reference to a working example. The accompanying drawings show:

FIG. 1: the paper or paper scraps softened in a vessel during the comminuting operation;

FIG. 2: the briquet dewatered by pressing; and

FIG. 3: a block produced and graphitized in accordance with the invention and having high density.

### DETAILED DESCRIPTION

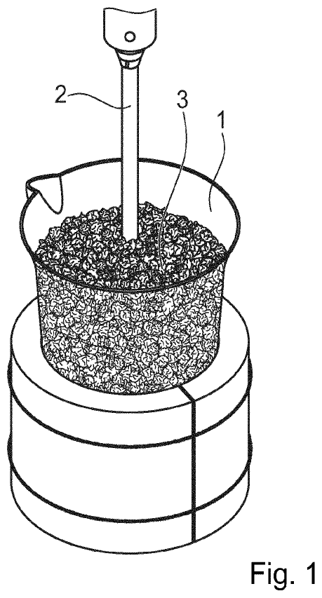

For the production of a graphitized block, first of all, paper/used paper, paper scraps or paper strips are softened in water in a suitable vessel 1 of any size over several hours, for example over 24 hours. The softened paper is subsequently comminuted with a suitable apparatus 2 until a paste 3 or a mixture having paste-like consistency has formed (FIG. 1). The binder mixed into the paste 3 may be sugar or starch.

Suitable equipment for production of the paste 3, as well as a mixer, is also a meat grinder having a cutting propeller and conveying screw, or else an extruder, by means of which the conveying rate can be considerably increased.

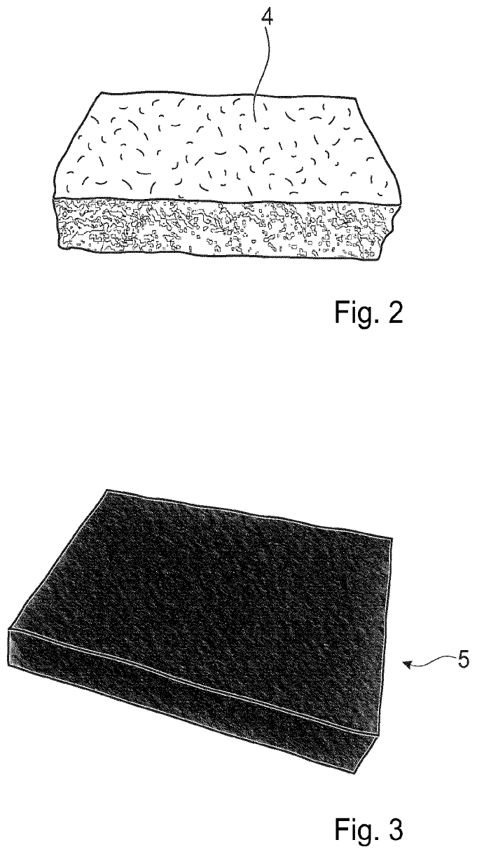

This paste 3 is introduced into a suitable mold and then the water is squeezed out of the paste by pressing, or the paste is subjected to isostatic pressing to obtain a briquet 4, as shown in FIG. 2.

The apparatus used to press the paste may be a mold which is open on two opposite sides, for example an angular mold, in which the lower opening is closed by a screen, or a perforated plate or the like. Alternatively, it is also possible to use a mold which is open at the top. The pressing operation can then be effected in a simple manner by pressing a suitable ram from above into the respective mold, as a result of which the water expressed is either pushed out through the screen or—in the case of an intrinsically closed mold which is open only at the top—pushed upward, and can be poured off. The result in both cases is a compact briquet 4 (FIG. 2).

In order to be able to remove the briquet easily from the mold, the screen at the bottom should lie merely on an edge, such that the briquet 4 can simply be pushed out of the vessel after the pressing with which the screen.

Otherwise, the mold merely has to be overturned and the briquet 4 removed by knocking.

The briquet, prior to further processing, should be dried under air or in a suitable drying device in order to reduce or to very substantially prevent later outgassing. In this way, it is simultaneously possible to avoid the formation of cracks in the subsequent high-temperature treatment.

Subsequently, the dried briquet 4 can be carbonized as usual in a furnace at >1000° C. and then graphitized to a graphite block 5 at >2000° C. (up to a maximum of 3000° C.). The graphite block 5 can then be used further or processed as desired.

It will be apparent that both the carbonizing and the graphitizing have to be undertaken at least with exclusion of oxygen or under protective gas.

In order that the dewatered briquet 4 has better integrity and does not crumble after graphitization, a binder having good solubility in water, such as sugar or syrup, can be added to the softened paper, which is well distributed in a uniform manner in the paste.

Alternatively, it is also possible to mix starch, such as potato starch, corn starch, rice starch or the like, as binder into the paste or mixture having paste-like consistency.

It is particularly advantageous when the briquet 4 is dried prior to further processing by a high-temperature treatment, in order to reduce or to avoid later outgassing, with simultaneous avoidance of formation of cracks. The drying can be effected in a drying cabinet or a demoisturizing system, in order to accelerate the drying process.

### LIST OF REFERENCE NUMERALS

1 vessel
2 apparatus
3 paste
4 briquet
5 graphite block

1.-7. (canceled)

8. A process for producing graphite from paper for use as filter or building material, comprising:
softening paper, used paper, paper scraps, or paper strips in water in a vessel over several hours to produce softened paper;
mixing and comminuting the softened paper with an apparatus until a paste has formed, and mixing sugar or starch into the paste as binder;
introducing the paste into a mold and squeezing the water out of the paste by pressing, or isostatically pressing the paste, to obtain a briquet;
removing the briquet from the mold and subjecting the briquet to a drying process; and
carbonizing the briquet in a furnace at a first temperature >1000 C. and then graphitizing the briquet at a second temperature between 2000° C. and 3000° C.

9. The process as claimed in claim 8,
wherein both the carbonizing and the graphitizing are undertaken with exclusion of oxygen or under protective gas.

10. The process as claimed in claim 8,
wherein the softening of the paper is undertaken over a period of about 24 hours.

11. The process as claimed in claim 8,
wherein the binder is sugar or syrup.

12. The process as claimed in claim 8,
wherein the binder is starch.

13. The process as claimed in claim 12,
wherein the starch is potato starch, corn starch, or rice starch.

14. The process as claimed in claim 8,
wherein the drying process is undertaken in a drying cabinet or a demoisturizing system.
